(19) United States
(12) Patent Application Publication
(10) Pub. No.: US 2015/0007216 A1
(43) Pub. Date: Jan. 1, 2015

(54) SYSTEM FOR READING DIGITAL CONTENT AND CORRESPONDING METHOD OF READING

(71) Applicant: BOUYGUES TELECOM, Paris (FR)

(72) Inventor: Simon Guerout, Saint Ouen (FR)

(73) Assignee: BOUYGUES TELECOM, Paris (FR)

(21) Appl. No.: 14/377,817

(22) PCT Filed: Feb. 8, 2013
(86) PCT No.: PCT/EP2013/052567

§ 371 Date: Aug. 8, 2014

(30) Foreign Application Priority Data
Feb. 8, 2012 (FR) 1251173

(51) Int. Cl. H04N 21/418; H04N 21/4408; H04N 21/4405; H04N 21/4147; H04N 21/4627

(52) U.S. Cl. CPC H04N 21/4181; H04N 21/4147; H04N 21/4627; H04N 21/4405; H04N 21/4408
USPC 725/31

(57) ABSTRACT

The invention proposes a system for reading digital content comprising:—a device for access to a computer network;—a device for reading digital content able to communicate with the device for access to a computer network via a connection interface, and adapted for implementing at least one software application, and—an access control module able to encrypt or decrypt digital streams, the access control module being associated with the device for reading digital content and connected to the device for access to a computer network, in which the digital application or applications of the reading device communicate with the access control module via the network access device, and said communication is implemented by means of server software hosted by the access control module or the access device. The invention furthermore proposes a method of reading a digital content implemented by the system.

### FIELD OF THE INVENTION

The field of the invention is that of access to encrypted digital content, especially for downloading, recording and reading such content.

The invention applies especially to digital content reading systems, such as televisions connected to a network.

### PRIOR ART

Examples of recent televisions are so-called connected televisions in that they are connected to the Internet, typically via an integrated access device (IAD).

Some programs are sometimes encrypted to limit their broadcast. This is especially the case for paid programs such as video on demand (VOD).

To ensure decryption of these programs, televisions are fitted with connection of <<common interface [symbol] ( [symbol] CI [symbol] , or [symbol] CI+ [symbol] ) type for connecting a conditional access module (CAM) adapted to decrypt encrypted digital streams.

This is for example a teaching from document WO 2011/070036, which describes a digital video recorder which can be connected to or integrated into a digital content reading device such as a television. This digital video recorder further comprises a conditional access module and a connection interface to a network by means of which the conditional access module retrieves information necessary to perform decryption of digital content.

The requests for decryption of digital content can originate from an application hosted by the reading device or one of these peripherals (for example a VOD application, a recording application, a software gadget of [symbol] widget [symbol] type etc.).

These applications are sometimes not adapted to communicate with a conditional access module, and sending decryption requests to such a module is not possible because there is no programming interface between the application and the module enabling dialogue between the application and the module.

The only solution proposed to date is a television in which such a programming interface has been initially provided.

This does not however resolve the problem of lack of communication between an application and a conditional access module for existing televisions.

Document US 2010/313225 also discloses a system enabling conversion of digital content stored on a digital content reader before any content is sent to the network. Conversion is done by a processor capable of encrypting or decrypting digital streams.

In this document, applications contained in the digital content reader therefore communicate with the processor to perform conversion of the digital content, before any of said content is sent via a computer network.

The system described in this document relates to an entirely different problem and especially does not bring up the problem described hereinabove, as in this document software applications do not try to decrypt a stream of digital content coming from a network.

### PRESENTATION OF THE INVENTION

The aim of the present invention therefore is to eliminate the above problem. In particular, one of the aims of the invention is to allow an application hosted by a digital content reading device to dialogue with a conditional access module, in the absence of a programming interface provided specially for this purpose.

In this respect, the invention proposes a digital content reading system comprising:
a computer network access device;
a digital content reading device able to communicate with the computer network access device via a connection interface, and adapted to execute at least one software application, and a conditional access module capable of encrypting or decrypting digital streams, the conditional access module being connected to the digital content reading device and connected to the computer network access device,

the system being characterized in that the digital application(s) of the reading device communicate with the conditional access module via the network access device, and in that said communication is implemented by means of server software hosted by the conditional access module or the access device.

The invention is advantageously completed by the following characteristics, taken alone or in any one of their technically possible combinations:
the server software is hosted by the conditional access module, and said applications run client software able to communicate with the server software, or the server software is hosted by the network access device, and the conditional access module and said applications run client software able to communicate with the server software;
the server and client software use at least one communication protocol selected from the following group: ip, tcp, udp, http;
the conditional access module is connected to the digital content reading device by means of a common interface;
the conditional access module has a connection interface ensuring its connection with the network access device;
the conditional access module is adapted to communicate with the connection interface of the reading device and is connected to the network access device via said connection interface.

The invention further provides a conditional access module adapted to be connected to a digital content reading device adapted to execute at least one software application and connected to a computer network via an access device to said network, the conditional access module hosting server or client software enabling communication between said conditional access module and the software application(s) via the network access device.

The invention finally provides a process for reading digital content executed by the system according to the invention, wherein a user executes an application for loading an encrypted digital content by executing the following steps:
the application determines information relative to the encrypted digital content,
the application sends a request containing said information to the server software hosted on the computer network access device or the conditional access module,
the conditional access module retrieves said information and from this information retrieves decryption keys available on the network and necessary for decryption of the encrypted digital content,
the reading device sends the encrypted digital content to the conditional access module,
from the decryption keys and of the encrypted digital content, the conditional access module decrypts the digital content and sends it to the reading device and

the reading device reads the digital content.

Advantageously, though optionally, the process according to the invention can further comprise at least one of the following characteristics:
the server software is hosted on the network access device, and during the retrieval step of information by the conditional access module the network access device forwards the application request to the conditional access module;
the application is hosted by the digital content reading device or by a peripheral connected to the latter;
the application is a video on demand application.
the information necessary for decryption of the digital content comprise information on rights relative to digital content, and/or cryptographic information.

### PRESENTATION OF FIGURES

Other characteristics, aims and advantages of the invention will emerge from the following description which is purely illustrative and non-limiting, and which must be considered with respect to the appended drawings, wherein:

FIGS. 1a, 1b, and 1c illustrate different embodiments of the digital content reading system according to the invention.

FIGS. 2a and 2b illustrate two alternative embodiments of client-server architecture implemented in the system according to the invention.

FIG. 3 illustrates the main steps of the

### DETAILED DESCRIPTION OF AT LEAST ONE EMBODIMENT

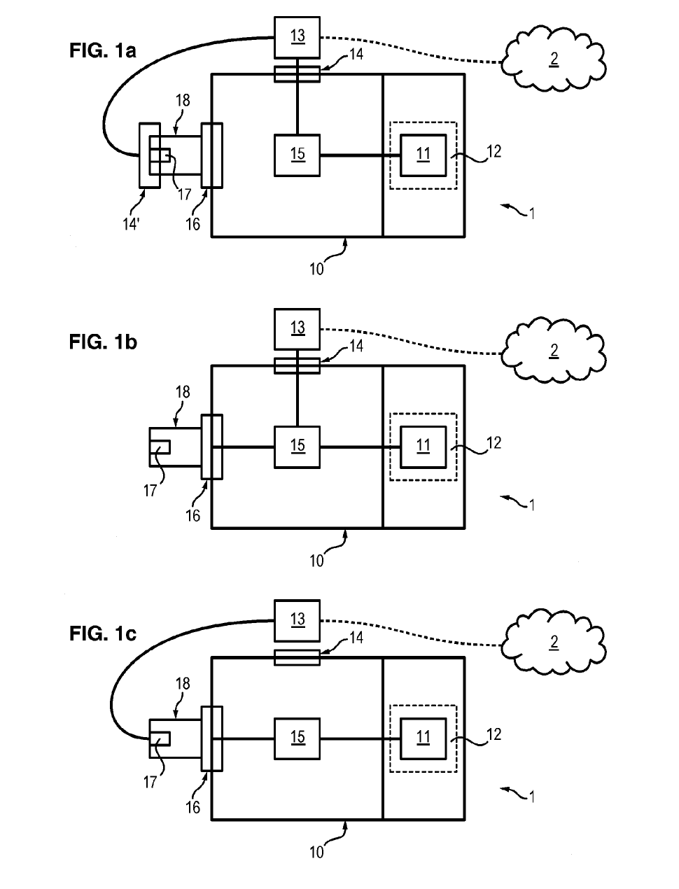

FIGS. 1a, 1b and 1c show three separate embodiments of the digital content reading system according to the invention.

In a way common to each of these embodiments, the system 1 according to the invention comprises a digital content reading device 10. This device is connected, that is, it is connected to a computer network such as the Internet.

Preferably, though non-limiting, the device 10 is a connected television.

This digital content reading device 10 is adapted to execute at least one software application 11, which can be hosted by the reading device 10 itself, or alternatively by a peripheral 12 connected to the device.

The application(s) 11 are applications for reading encrypted content, such as for example a video on demand application (VOD), a recording application, or a software gadget of [symbol] widget [symbol] type, etc.

The peripheral 12 can be for example a digital video recorder, storage media, for example in the case of a recording application 11, or even a digital tablet, a telephone of [symbol] smartphone [symbol] type, or any other device adapted to host at least one software application. More generally, the peripheral 12 is any peripheral of DLNA type, that is, adapted to execute the DLNA interoperability standard, or any network protocol for controlling reading ( [symbol] player [symbol] ) programs of the reading device 10.

The system 1 for reading digital content further comprises a computer network 2 access device 13 such as the Internet, this device 13 preferably being an integrated access device of IAD type.

As a connected device, the reading device 10 preferably though non-limiting comprises a connection interface 14 enabling it to communicate with the network access device 13.

The reading device 10 is provided with classic computer architecture known per se, comprising in particular middleware 15 ensuring communication between the application(s) 11 and the connection interface 14.

The device 10 is further equipped with connection 16 of CI or CI+ [symbol] common interface [symbol] type, typically in the form of an adapted port, into which an additional external module, typically a conditional access module, can be inserted.

The system 1 for reading digital content further comprises a conditional access module 17 which is conventionally integrated into a cartridge equipped with a connection CI or CI+18 adapted to communicate with the device 10 via the connection 16. The conditional access module 17 is adapted to encrypt or decrypt streams read by the reading device 10, these streams corresponding typically to encrypted chains.

The conditional access module can also be connected to the computer network 2, either by an owned interface network, or via the middleware 15 of the reading device 10.

As has been evident previously, classic televisions connected have no communication link between the applications 11 and the conditional access modules 17. In particular, the middleware 15 of the reading device 10 comprises no programming interface which can let applications 11 dialogue with the conditional access module 17.

Consequently, when execution of an application requires decryption of a digital stream by the conditional access module, this execution is impossible in this type of reading device 10.

To rectify this disadvantage, the system 1 according to the invention sets up a communication link between the applications 11 and the conditional access module 17, by means of the network access device 13.

In reference to FIGS. 1a to 1c, the conditional access module 17 is connected, as is the reading device 10, to the network access device 13.

In a first case illustrated in FIG. 1a, the conditional access module 17 can be equipped with its own connection interface 14′ to communicate with the network access device 13.

This embodiment has the advantage of a high rate, the conditional access module being fitted with its own connection interface. Also, it does not modify the television.

However, from the equipment viewpoint, this embodiment can increase the number of cables necessary for the different connection.

In the second case, in FIG. 1b, the conditional access module has no connection interface per se, but is connected to the network access device 13 via the middleware 15 of the reading device 10.

This embodiment has the advantage of keeping a physical module consistent with the modules proposed commercially to date. However, the rate of the connection of the module via the connection interface of the reading device can prove too low to retrieve large-sized streams.

In the third case, in FIG. 1c, the reading device 10 has no connection interface per se, with the difference of the conditional access module which has one 14. In this case, the reading device 10 is connected to the network access device 13 via the connection interface 14 of the conditional access module and the middleware of the reading device 10.

Also, to ensure communication between the applications 11 and the conditional access module 17, client-server architecture is implemented in the system 1.

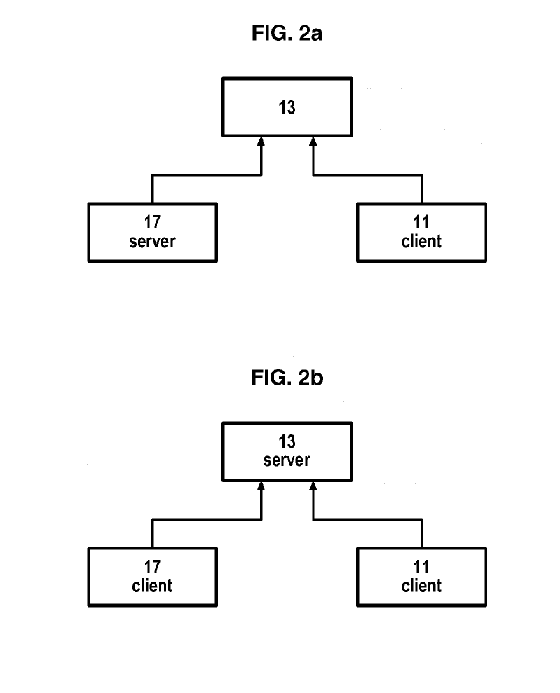

According to a first embodiment illustrated in FIG. 2a, server software is hosted by the conditional access module, and corresponding client software is hosted by the reading device 10 or the peripheral 12, such that the application 11 is capable of running said client software.

The network access device 13 plays the role of router to transfer requests coming from the client software to the server software.

According to an alternative embodiment illustrated in FIG. 2b, the server software is hosted by the network access device 13. In this case, the conditional access module 17, as well as the reading device 10 or the peripheral 12, host corresponding client software.

The client/server software uses a communications network based on IP protocol, and the communication protocol used is selected from udp or tcp. The application layer is performed by http protocol.

Where appropriate, proprietary protocols can be developed for this use.

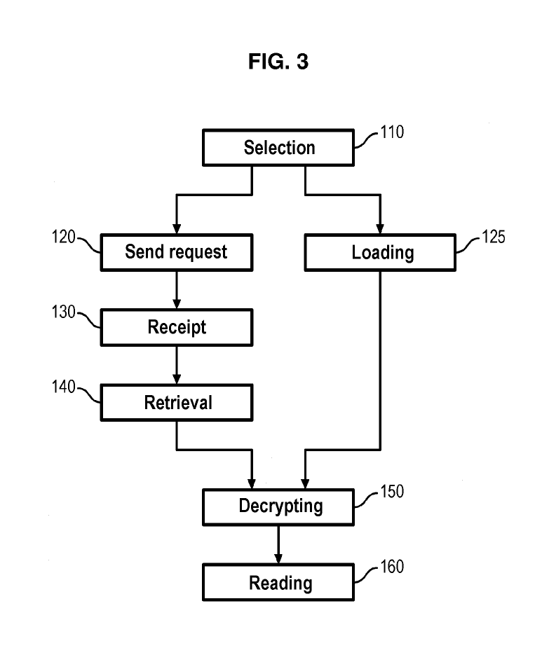

In reference to FIG. 3, this shows the main steps of the process for reading digital content executed by the system described previously.

During a step 110, a user launches an application to select and read determined encrypted content. This encrypted content is characterized by some information, on the one hand, on the content itself such as its URL, or a reference to a catalogue. This information is retrieved by the application 11 to allow loading of the content by the reading device 10.

On the other hand, the application determines other information on the encrypted content, and which is necessary for its decryption.

This information can be information on the owner of rights and/or the usage rights of the content, for example licenses to this content, on the user, or cryptographic information such as initialisation vector, digital signature etc.

Obtaining this information by the conditional access module is necessary for the latter to deduce therefrom the data to be retrieved on the network 2 to decrypt the content.

So the application 11 determines this information necessary for decryption of the content, and during a step 120 sends a request containing this information to the server hosted on the network access device or on the conditional access module.

During a step 130, the conditional access module retrieves the request. In the event where the server is hosted on the network access device, the latter forwards the request in <<push>> communication mode to the client hosted by the conditional access module.

Once the conditional access module has information necessary for decryption, it retrieves on the network 2, during a step 140 known per se, the decryption keys corresponding to the content to be decrypted. Where appropriate, it can also deduce the decryption keys from the information contained in the application request.

In line with these steps, the application 11 determines the information on the content itself and communicates it to the reading device during a step 125 so that the reading device can load the content, for example from the network via the network access device 13.

The conditional access module can then decrypt the content during a decryption step 150, and the content is read by the device 10.

For this to happen, the device 10 communicates to the conditional access module the content to be decrypted (for example content VOD type) via the common interface. The conditional access module decrypts the content by means of keys previously obtained, and sends the decrypted content to the device 10.

During a step 160 the latter can read the content by means of a classic reading algorithm.

Optionally, if a storage peripheral 12 is connected to the reading device 10, the decrypted stream can be recorded on the storage peripheral.

The invention therefore resolves the communication defect between an application controlled by a user and a conditional access module. In addition, as a function of the embodiment adopted, it is possible for the user to keep his television or his conditional access module.

1. A digital content reading system (1) comprising:
a computer network access device (13);
a digital content reading device (10) able to communicate with the computer network (2) access device (13) via a connection interface (14), and adapted to execute at least one software application (11), and
a conditional access module (17) capable of encrypting or decrypting digital streams, the conditional access module (17) being connected to the digital content reading device (10) and connected to the computer network (2) access device (13),
the system being characterized in that the digital application(s) (11) of the reading device (10) communicate with the conditional access module (17) via the network access device (13), and in that said communication is carried out by means of server software hosted by the conditional access module (17) or the access device (13).

2. The system (1) for reading digital content according to claim 1, wherein the server software is hosted by the conditional access module (17), and said applications (11) run client software able to communicate with the server software.

3. The system (1) for reading digital content according to claim 1, wherein the server software is hosted by the network access device (13), and the conditional access module (17) and said applications (11) run client software able to communicate with the server software.

4. The system (1) for reading digital content according to any one of claim 2 or 3, wherein the server and client software use at least one communication protocol selected from the following group: ip, tcp, udp, http.

5. The system (1) for reading digital content according to any one of the previous claims, wherein the conditional access module (17) is connected to the digital content reading device (10) by means of a common interface.

6. The system (1) for reading digital content according to any one of the previous claims, wherein the conditional access module (17) has a connection interface (14′) ensuring its connection with the network access device (13).

7. The system (1) for reading digital content according to any one of the previous claims, wherein the conditional access module (17) is adapted to communicate with the connection interface (14) of the reading device (10), and is connected to the network access device (13) via said connection interface.

8. A conditional access module (17) adapted to be connected to a digital content reading device (10) adapted to execute at least one software application (11) and connected to a computer network (2) via an access device (13) to said network,
the conditional access module (17), being characterized in that it hosts server or client software enabling communication between said conditional access module (17) and the software application(s) (11) via the network access device (10).

9. A process for reading of digital content executed by the system according to any one of the previous claims, wherein a user executes an application (11) for the loading of encrypted digital content by executing the following steps:
the application (11) determines information relative to the encrypted digital content,
the application (11) sends a request containing said information to the server software hosted on the computer network access device (13) or the conditional access module (17),
the conditional access module (17) retrieves said information and from this information retrieves decryption keys available on the network and necessary for decryption of the encrypted digital content,
the reading device (10) sends the encrypted digital content to the conditional access module (17),
from the decryption keys and the encrypted digital content, the conditional access module (17) decrypts the digital content and sends it to the reading device (10), and
the reading device (10) reads the digital content.

10. The process for reading digital content according to the previous claim, wherein the server software is hosted on the network access device (13), and during the retrieval step of information by the conditional access module (17) the network access device (13) forwards the application request to the conditional access module (17).

11. The process for reading digital content according to the previous claim, wherein the application (11) is hosted by the digital content reading device (10) or by a peripheral (12) connected to the latter.

12. The process for reading digital content according to any one of claims 9 to 11, wherein the application (11) is a video on demand application (11).

13. The process for reading digital content according to any one of claims 9 to 12, wherein the information necessary for decryption of the digital content comprises information on rights relative to digital content, and/or cryptographic information.
